(19) United States
(12) Patent Application Publication
(10) Pub. No.: US 2013/0250839 A1
(43) Pub. Date: Sep. 26, 2013

(54) METHOD AND DEVICE FOR ACQUIRING SYNCHRONIZATION BETWEEN NODES AND METHOD FOR ORGANIZING MULTIPLE PHYSICAL CHANNELS

(71) Applicant: Electronics and Telecommunications Research Institute, Daejeon (KR)

(72) Inventors: Choongil LEE, Daejeon (KR); Byung-Jae Kwak, Seoul (KR); Dong Seung Kwon, Daejeon (KR); Dong Hyun Ahn, Daejeon (KR)

(73) Assignee: Electronics and Telecommunications Research Institute, Daejeon (KR)

(21) Appl. No.: 13/892,655

(22) Filed: May 13, 2013

Related U.S. Application Data
(62) Division of application No. 12/763,826, filed on Apr. 20, 2010.

(30) Foreign Application Priority Data
Apr. 21, 2009 (KR) 10-2009-0034639
Jun. 24, 2009 (KR) 10-2009-0056588

(51) Int. Cl. H04W 76/00

(52) U.S. Cl. CPC H04W 76/002
USPC 370/312

(57) ABSTRACT

A method for acquiring synchronization between nodes and configuring multiple physical channels in order to improve performance in the ad-hoc/mesh network is disclosed.

### CROSS-REFERENCE TO RELATED APPLICATION

This application is a divisional of U.S. Ser. No. 12/763,826, filed Apr. 20, 2010, which claims priority to and the benefit of Korean Patent Applications No. 10-2009-0034639 filed in the Korean Intellectual Property Office on Apr. 21, 2009 and No. 10-2009-0056588 filed in the Korean Intellectual Property Office on Jun. 24, 2009, the entire contents of which are incorporated herein by reference.

### BACKGROUND OF THE INVENTION

(a) Field of the Invention

The present invention relates to an inter-node synchronization acquisition method and device, and a multiple physical channel configuration method. Particularly, the present invention relates to an inter-node synchronization acquisition method and device, and a multiple physical channel configuration method in an ad-hoc/mesh network.

(b) Description of the Related Art

Wireless communication systems are generally classified as infrastructure systems and non-infrastructure systems. The representative example of the infrastructure systems is the cellular system in which each cell is configured with a base station and a plurality of terminals. In the cell, the base station has a centralized control right and allocates resources to the terminals. That is, the infrastructure system requires a central coordinator having a centralized control right in a like manner of the base station.

The non-infrastructure system represented as the ad-hoc/mesh network has no central coordinator, and the nodes respectively become a coordinator to use the resource. These systems use a common resource (or channel) and all the terminals transmit/receive information, and hence, an algorithm for preventing collision caused by concurrently using the same channel and another algorithm for solving the collision are needed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for nodes to acquire synchronization so as to improve performance of an ad-hoc/mesh network, and a multiple physical channel configuration method for efficiently using public radio frequency resources, that is, communication media, between the nodes.

Throughput is substantially improved when the nodes have a common time reference in the ad-hoc/mesh network. Further, spectrum usage efficiency is improved when the ad-hoc/mesh network is configured with multiple physical channels compared to the case in when the same is configured with a single physical channel.

An exemplary embodiment of the present invention provides a method for acquiring synchronization between nodes in a network in which first nodes with a global time reference and second nodes without a global time reference are provided, including: allowing a second node existing in a predetermined range of the first node to detect a preamble; allowing the second node to generate a pulse when the detected preamble outputs a peak waveform for each period; allowing the second node to generate a preamble output time based on the generated pulse and a predetermined clock signal; and allowing the second node to output the preamble based on the generated output time.

Another embodiment of the present invention provides a device for acquiring synchronization between nodes in a network in which first nodes with a global time reference and second nodes without a global time reference are provided, including: a detector for detecting preambles of the second nodes existing in a predetermined range of the first node; a generator for generating a pulse when the detected preamble outputs a peak waveform for each predetermined period; and a phase locked loop for generating a preamble output time based on the generated pulse and a self-running clock signal, and outputting the preamble to the second node based on the generated preamble output time.

Yet another embodiment of the present invention provides a method for configuring multiple physical channels in an ad-hoc/mesh network, including: configuring multiple physical channels based on a single radio frequency device, multiple control common physical channels, multiple data common physical channels, and multiple broadcasting common physical channels; and configuring the multiple physical channels based on a single MAC for controlling the multiple physical channels.

### BRIEF DESCRIPTION OF THE DRAWINGS

FIG. 1 shows a general ad-hoc/mesh network.

FIG. 2A to FIG. 2C show a case in which nodes with a global time reference and nodes without the global time reference are mixed together.

FIG. 3A to FIG. 3B show the case in which nodes receive a preamble, and a preamble output waveform of the corresponding receiving nodes.

FIG. 4 shows a block diagram of a global time reference acquisition device of the node having no global time reference according to an exemplary embodiment of the present invention.

FIG. 5 shows a structure of multiple radio frequency devices for ad-hoc/mesh network, multiple common physical channels, and a media access control.

FIG. 6 shows a method for configuring multiple common physical channels in the single radio frequency device for the ad-hoc/mesh network, multiple common physical channels, a single MAC structure, and the OFDMA system.

FIG. 7 shows a method for the respective nodes to transmit/receive information by using multiple common physical channels in the ad-hoc/mesh network.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

An inter-node synchronization acquisition method and device, and a multiple physical channel configuration method in the ad-hoc/mesh network according to an exemplary embodiment of the present invention will now be described with reference to accompanying drawings.

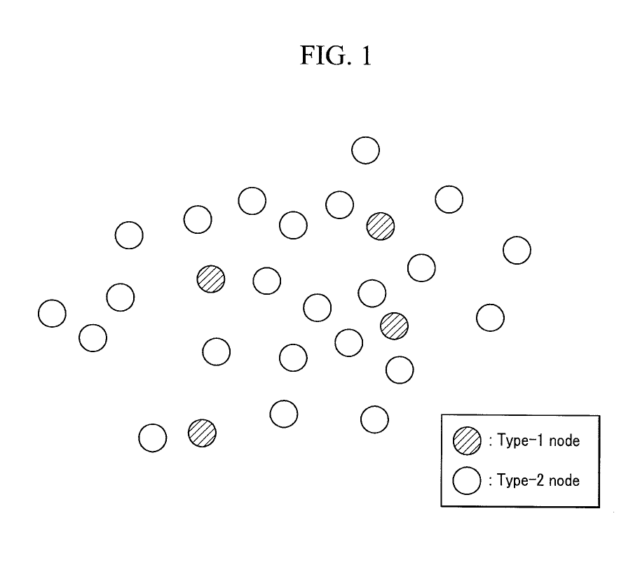

FIG. 1 shows a general ad-hoc/mesh network.

First, an ad-hoc/mesh network configured with a plurality of nodes will be assumed. Further, it will be assumed that at least one of the nodes existing in the ad-hoc/mesh network has the global time reference, and other nodes have no global time reference and are operable by the self-running clock. The above-noted environment setting can be considered under the situation of army use, disaster, and prevention of disasters.

FIG. 1 shows an ad hoc/mesh network including nodes with a global time reference (Type-1 nodes) and nodes without a global time reference (Type-2 nodes).

One of the objects of the present invention is to provide a method for the nodes that are operable by the self-running clock under the above-noted situation to acquire the global time reference.

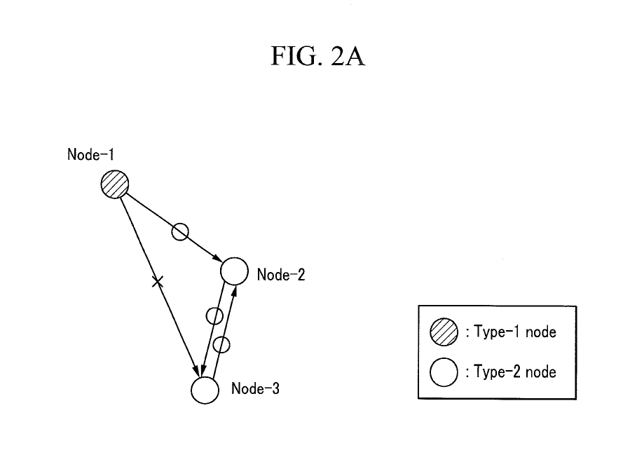

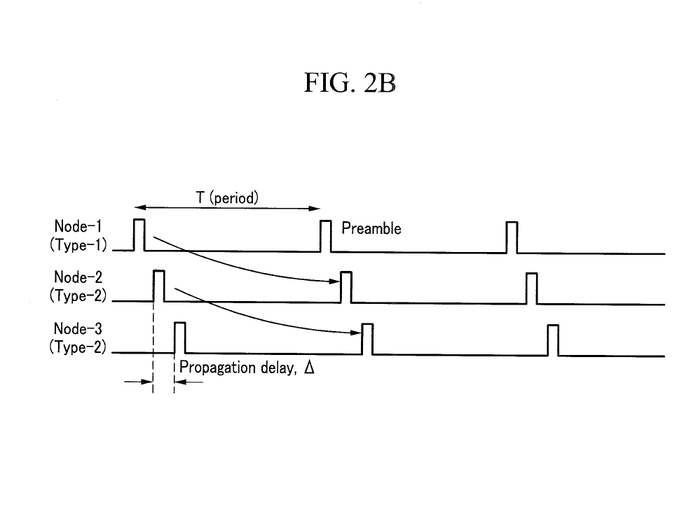

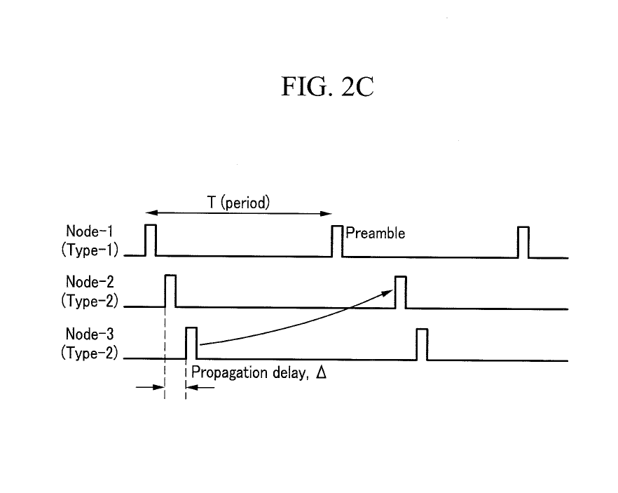

FIG. 2A to FIG. 2C show the case in which nodes with a global time reference and nodes without the global time reference are mixed together.

An ad-hoc/mesh network having one type-1 node (node-1) and two type-2 nodes (node-2 and node-3) are assumed to check a problem regarding node synchronization acquisition in FIG. 2A. Also, it is assumed in FIG. 2A that the node-2 can receive a signal from the node-1 and node-3, and the node-3 can receive a signal from the node-2 but not from the node-1. The nodes can transmit a preamble in a predetermined waveform for synchronization. Type-1 node outputs the preamble for each predetermined period since it has the global time reference. Since Type-2 node has no global time reference, it indirectly uses the preamble output by the type-1 node to acquire the global time reference and then it outputs the preamble.

FIG. 2B to FIG. 2C show the problem that may occur in the above-noted case.

FIG. 2B shows the case in which the node-2 outputs a preamble with reference to preamble receipt of the node-1 and the node-3 outputs a preamble with reference to preamble receipt of the node-2. In this instance, there is an error caused by propagation delay, and the nodes can be synchronized. However, when the node-2 outputs a preamble with the reference to preamble receipt of the node-3 as shown in FIG. 2C, synchronization cannot be acquired. When the number of nodes is increased and the size of the network is increased, synchronization acquisition becomes further difficult.

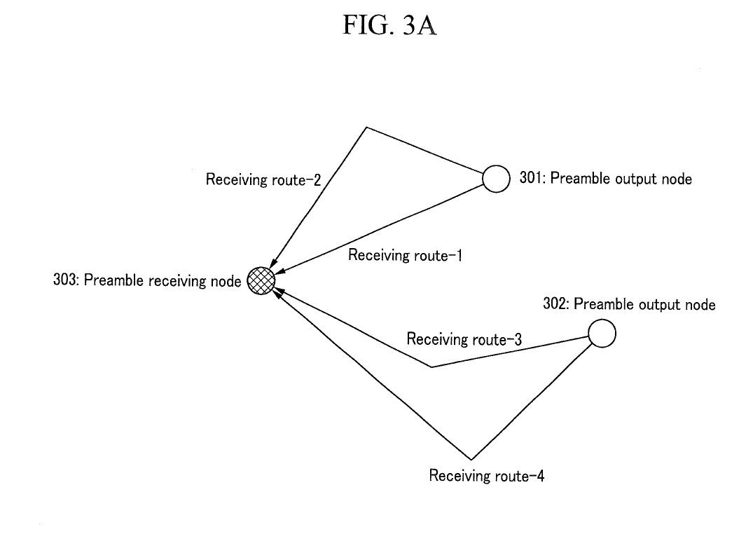

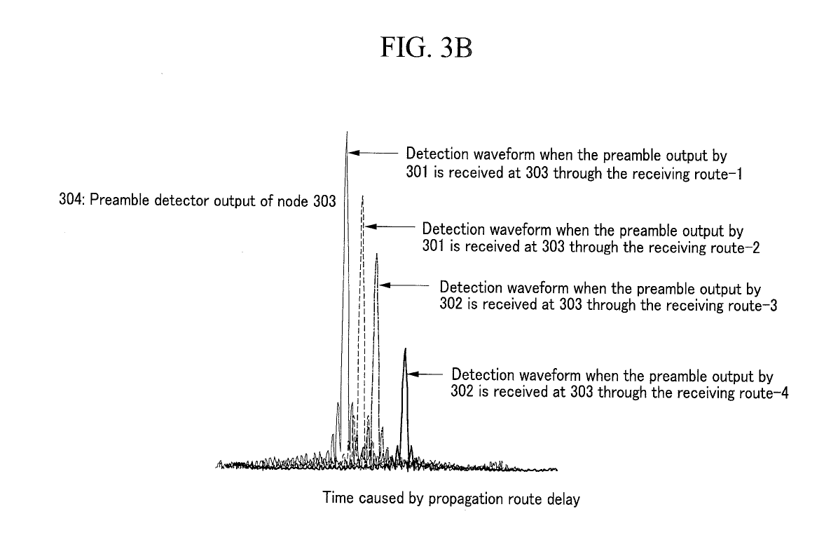

A preamble output waveform of a receiving node when nodes receive a preamble will now be described with reference to FIG. 3A to FIG. 3B.

FIG. 3A to FIG. 3B show the case in which nodes receive a preamble, and a preamble output waveform of the corresponding receiving nodes.

Referring to FIG. 3A, the preamble is sequentially received at the receiving node with a temporal gap according to the output node location and propagation route. When using the same form of the predetermined preamble waveform, a preamble detector (not shown) of the node-303 outputs a plurality of detection peak waveforms when the node-301 and the node-302 simultaneously output the preamble because of a propagation route difference. In general, the preamble detector detects the preamble by using the correlation method.

FIG. 3B shows an output waveform of the preamble detector of the receiving node.

Referring to FIG. 3B, in order to solve the problem generated during inter-node synchronization acquisition described in FIG. 2C, the type-1 nodes output a preamble for each period with reference to the global time reference, and the type-2 nodes acquire a global time reference and output a preamble according to the subsequent process.

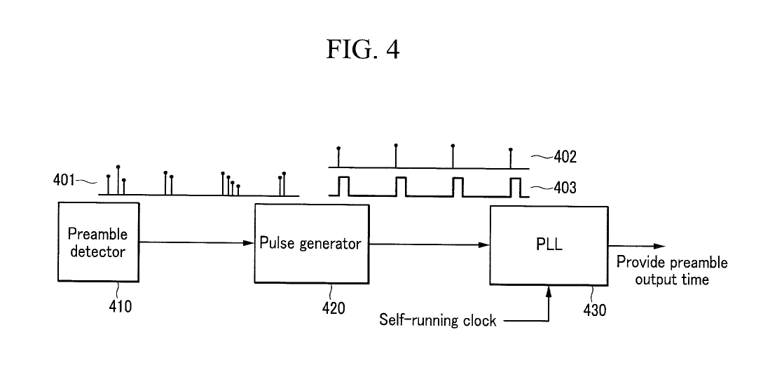

FIG. 4 shows a block diagram of a global time reference acquisition device of the node having no global time reference according to an exemplary embodiment of the present invention.

Referring to FIG. 4, a synchronization acquisition device 400 of the type-2 node includes a preamble detector 410, a pulse generator 420, and a phase locked loop (PLL) 430.

1) When power is supplied to the type-2 node, the pulse generator 420 outputs a pulse at the time when the preamble detector 410 outputs an initial effective peak waveform for each period. The reference numeral 401 shows an output waveform of the preamble detector 410, and the reference numeral 403 shows an output waveform of the pulse generator 420.

2) The pulse sequence 403 generated in 1) and the self-running clock signal 406 are provided to the PLL 430 so that the PLL 430 of the type-2 node may generate a stable preamble transmitting time.

3) When the output of the PLL 430 of the type-2 node is stabilized, the type-2 node starts outputting the preamble.

According to the above-noted method, when the nodes do not have the global time reference a right is provided to a specific node and the same process is applied, and the nodes in the network can be synchronized with the node to which the right is provided.

As the throughput is improved when a multiple access protocol has a global time reference, the throughput when there are multiple common channels is improved compared to the case of a single common channel.

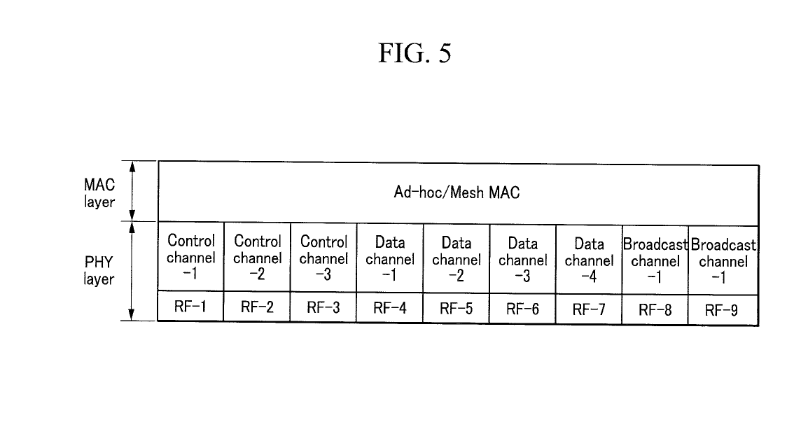

FIG. 5 shows a structure of multiple radio frequency devices for ad-hoc/mesh, multiple common physical channels, and a media access control.

In detail, FIG. 5 shows a plurality of physical control channels (e.g., 3 channels installed in a node) for handshaking, a plurality of physical data channels (e.g., 4 channels) for transmitting data, a plurality of physical broadcasting channels (e.g., 2 channels) for providing broadcasting information, radio frequency devices (or RF transceivers) (RF-1 to- RF-9) for physical layers, and a media access control (MAC) for controlling the physical channels.

The broadcasting channel is configured with a header and a payload, and it transmits information to all or some group nodes existing in the ad-hoc/mesh network. The control channel transmits information for negotiating various parameters for setting a channel between nodes before the channel is opened. The data channel includes a header and a payload, and the payload includes user data.

In order to improve the throughput in the ad-hoc/mesh network, the nodes can include multi-RF devices, multiple common physical channels, and a single MAC as shown in FIG. 5. However, when the nodes are configured as shown in FIG. 5, the cost is substantially increased.

When the orthogonal frequency division multiple access (OFDMA) is used in the ad-hoc/mesh network assuming the global time reference, the effects of the multi-channels and the single MAC of FIG. 5 can be acquired without a great increase of cost.

The OFDM symbol includes a plurality of subcarriers. The subcarriers are divided to allocate part of the subcarriers so as to configure multiple broadcasting channels, another part of subcarriers are allocated so as to configure multiple control channels for handshaking, and a remaining part of the subcarriers are allocated so as to configure multiple data channels for transmitting data. In this case, a plurality of common channels can be controlled with a single RF device.

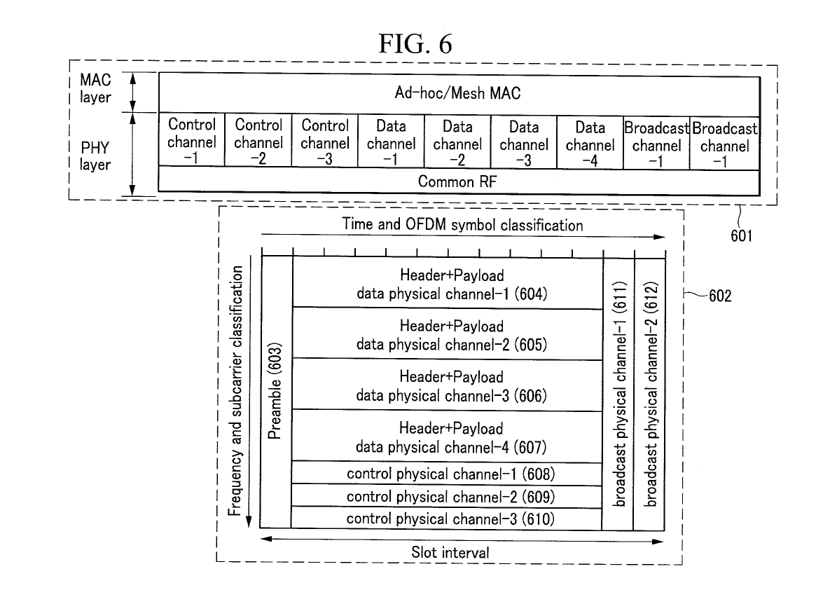

FIG. 6 shows a method for configuring multiple common physical channels in the single radio frequency device for the ad-hoc/mesh network, multiple common physical channels, a single MAC structure, and the OFDMA system.

The reference numeral 601 shows a node configuration including multiple OFDMA channels, a single radio frequency device, and a single MAC. The reference numeral 602 shows 3 control physical channels, 4 data physical channels, and 2 broadcasting physical channels. The preamble 603 is used when using the above-noted synchronization method, and it may not be needed when the node acquires synchronization through another method.

The case of FIG. 5 allows simultaneous transmitting/receiving and the case of 601 in FIG. 6 allows no simultaneous transmitting/receiving but substantially reduces the realization cost. In the case of the single RF device and multiple channels, since it is impossible to receive broadcasting signals while transmitting another channel, it is efficient to allocate the entire subcarriers to the broadcasting channel as shown by 611 and 612 in FIG. 6.

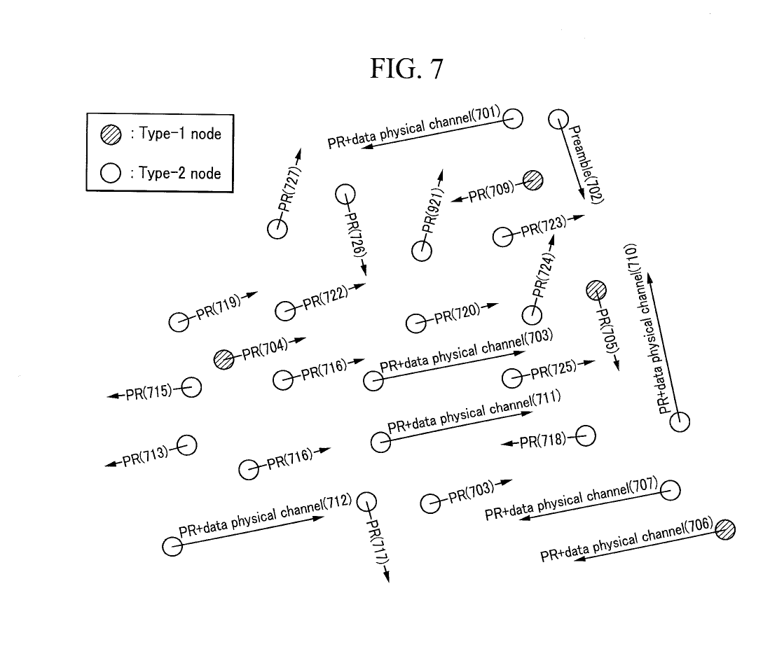

FIG. 7 shows a method for the respective nodes to transmit/receive information by using multiple common physical channels in the ad-hoc/mesh network.

Referring to FIG. 7, assuming that the node acquires synchronization according to the above-described method, the ad-hoc/mesh network uses the respective nodes' multiple channels. The nodes transmit/receive control information and user data information or transmit the same to other nodes for routing by using the multi-channels according to the dispersive collision prevention and solution MAC based on measurement (e.g., sensing carriers).

When using the above-described inter-node synchronization acquisition method of FIG. 7, the nodes 704, 705, 706, and 709 having a global time reference transmit a preamble for each time frame. Other nodes transmit a preamble by using the time reference that is acquired by using the received preamble. The respective nodes transmit/receive control and user information using the channel no other neighboring nodes use through measurement such as carrier sensing. When the node receives a broadcasting channel and retransmits the broadcasting channel at the next broadcasting channel transmission time, broadcasting information can be transmitted to all nodes over multiple hops. Information such as control that is common to all nodes can be transmitted to all nodes by the multi-hop method by using the broadcasting channel. FIG. 7 shows an example of using multiple channels in which the node 706 transmits/receives information by using the data physical channel-1, the node 710 transmits/receives information by using the data physical channel-3, the node 703 transmits/receives information by using the control physical channel-2, and the node 711 transmits/receives information by using the data physical channel-2. Improved processing rates can be acquired by realizing the collision prevention and collision solution algorithm using multi-channels.

The numbers of the data physical channel, the control physical channel, and the broadcasting physical channel are changeable. However, all nodes must recognize the change of number thereof. When the number of channels is to be changed, it is notified to all nodes in the network by using the broadcasting channel.

When the node receives a broadcasting message from a slot through the broadcasting physical channel, the node retransmits the same broadcasting message as the received one by using the broadcasting physical channel of the next slot. The node can receive it when a plurality of nodes transmit the same information with the same waveform in the OFDM system (SFN: single frequency network). All nodes can receive the broadcasting information by using the multi-hop method. However, when all nodes continue to retransmit the broadcasting message, the same broadcasting message is retransmitted in the network. To prevent the problem, a message number is assigned to the broadcasting message, and the nodes are controlled to transmit the broadcasting message having the same message number not more than n times.

According to an embodiment of the present invention, when a plurality of physical channels are utilized as a common resource, a performance-improving algorithm for preventing collision and solving the collision can be provided, and when all the nodes are synchronized in the non-infrastructure system, channel usage efficiency can be substantially improved.

Also, according to an exemplary embodiment of the present invention, the nodes without a global time reference can acquire the global time reference through the completely dispersed method without exchanging information between the nodes in the ad-hoc/mesh network. The throughput in the ad-hoc/mesh network can be improved when the nodes apply the collision preventing and collision solving algorithm to the inter-node synchronization acquisition device in the dispersed manner by using a multiple control physical channel, multiple data physical channels, and multiple broadcasting channels.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for configuring multiple physical channels in an ad-hoc/mesh network, comprising:
configuring multiple physical channels based on a single radio frequency device, multiple control common physical channels, multiple data common physical channels, and multiple broadcasting common physical channels; and
configuring the multiple physical channels based on a single MAC for controlling the multiple physical channels.

2. The method of claim 1, wherein
the number of control common physical channels, data common physical channels, and broadcasting common physical channels is variable, and
all nodes existing in the ad-hoc/mesh network recognize that the number of channels is variable.

3. The method of claim 2, wherein the method includes,
when at least a node of all nodes retransmits a broadcasting message,
assigning a proper number to the broadcasting message, and controlling the node to transmit a broadcasting message having the same proper number not more than a predetermined number of times.
